(19) United States
(12) Patent Application Publication
(10) Pub. No.: US 2007/0003356 A1
(43) Pub. Date: Jan. 4, 2007

(54) Foreign object deflector for a printer

(76) Inventor: Christa Ferguson, Round Rock, TX (US)

Correspondence Address: HAMILTON & TERRILE, LLP, P.O. BOX 203518, AUSTIN, TX, 78720, US

(21) Appl. No.: 11/173,027

(22) Filed: Jul. 1, 2005

(51) Int. Cl. B41J 29/12; B41J 29/00

(52) U.S. Cl. 400/693; 400/713

(57) ABSTRACT

A printer which includes a printer housing including a top portion and a sheet feeder positioned on the top portion of the printer housing is disclosed. The sheet feeder includes a foreign object deflector. The foreign object deflector includes a foreign object deflector panel. The foreign object deflector panel is positioned between the printer housing and a paper path of the sheet feeder.

### BACKGROUND OF THE INVENTION

1. Field of the Invention

The present invention relates to the field of printers and more particularly top loading printers.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems. One example of an information handing system is a printer.

Known printers have one of a plurality of types of paper paths. For example, one type of paper path via which printers can feed paper is where the paper is fed from a paper tray at the bottom of the printer. This type of printer is referred to as a bottom loading or C type paper path printer. Another type of paper path via which printers can feed paper is where the paper is fed from a paper tray at the top of the printer. This type of printer is referred to as a top loading or L type paper path printer.

One issue for L type printer path printers relates to foreign objects can fall into the auto sheet feeder of the printer, potentially causing paper jams. Often the user can not determine what the problem causing the paper jam is, possibly resulting in either the printer being returned to the printer supplier or a service call by the printer supplier.

Accordingly, it would be desirable to provide top loading printers with a mechanism for deflecting foreign objects before the objects can enter the paper path of the printer.

### SUMMARY OF THE INVENTION

In accordance with the present invention, a top loading printer is disclosed that includes a foreign object deflector in the auto sheet feeder.

More specifically, in one embodiment, the invention relates to a printer which includes a printer housing including a top portion and a sheet feeder positioned on the top portion of the printer housing. The sheet feeder includes a foreign object deflector. The foreign object deflector includes a foreign object deflector panel. The foreign object deflector panel is positioned between the printer housing and a paper path of the sheet feeder.

In another embodiment, the invention relates to an information handling system which includes a control system wherein the control system includes a processor, a printer housing with a top portion, and a sheet feeder positioned on the top portion of the printer housing. The sheet feeder includes a foreign object deflector. The foreign object deflector includes a foreign object deflector panel. The foreign object deflector panel is positioned between the printer housing and a paper path of the sheet feeder.

In another embodiment, the invention relates to an apparatus for printing documents which includes a control system wherein the control system includes a processor, a housing, the housing including a top portion, and, a sheet feeder positioned on the top portion of the housing. The sheet feeder includes a foreign object deflector. The foreign object deflector includes a foreign object deflector panel. The foreign object deflector panel is positioned between the printer housing and a paper path of the sheet feeder.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an environment in which a printer with an ink cartridge is shown.

FIG. 2 shows a perspective view of an example top loading printer.

FIG. 3 shows a top view of a top loading printer paper tray having a foreign object deflector.

FIG. 4 shows a side view of top loading paper tray having a foreign object deflector

### DETAILED DESCRIPTION

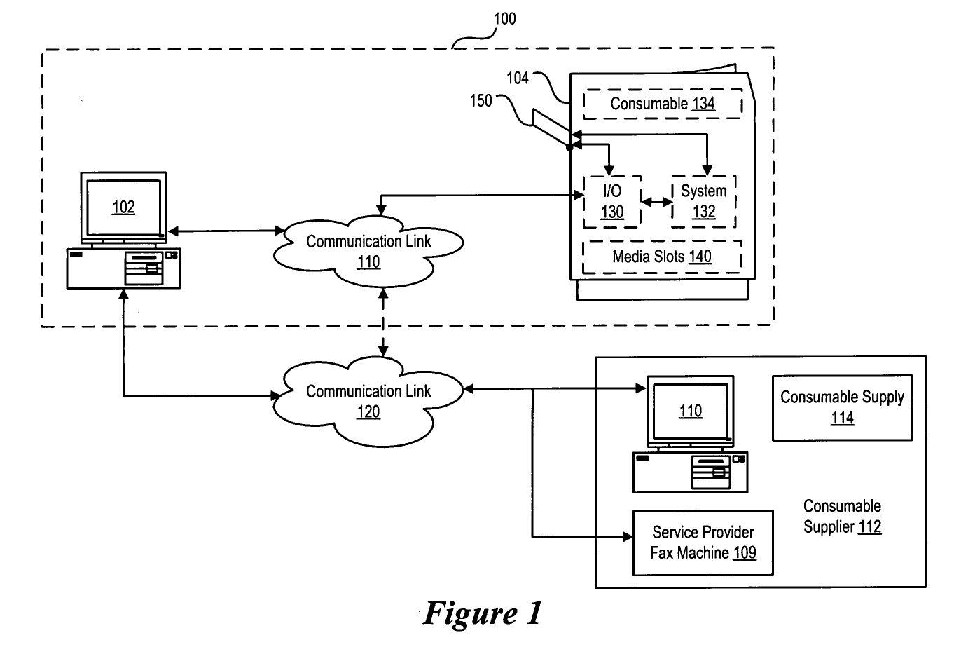

Referring to FIG. 1, a block diagram of an environment in which a printer with a foreign object deflector is shown. The environment includes an information handling system 102 (such as a computer system or a camera) and a printer 104, coupled via a communication link 110. The communication link 110 might be a printer cable, a telephone cable, a network connection or any other link which information is communicated with the printer 104. In one embodiment, the printer 104 is included within a multifunction device such as a combination printer fax machine. Other functions may also be included within the multifunction device such as a scan function and a copy function. Also, in one embodiment, the environment does not include a computer system 102.

The printer 104 is coupled to a second communication link 120. Thus, communication may occur between the printer 104 and anything coupled to the second communication link 120 such as a services provider fax machine 109. Additionally, the computer system 102 is also connected to another computer system (e.g., a services provider computer system) 110 via a second communication link 120. The second communication link 120 may be a telephone system or some other type of network, such as the Internet. In one embodiment, the fax machine 109 and the computer system 110 are owned and operated by a consumable supplier 112. In this example, the service provider 112 may provide service for the printer 104.

The printer 104 includes an input output (I/O) port 130, a control system 132 and at least two types of consumables 134. The I/O port 130 facilitates communications between the printer 104 and other devices connected to the communications link 110. The control system 132 provides the printer 104 with certain control functionality. The control system 132 includes a processor and memory coupled to the processor. The printer 104 may also include one or more media slots 140.

The consumables 134 represent any component in the printer 104 that is subject to depletion through use of the printer 104. For example, the consumable 134 may be a toner cartridge or an inkjet cartridge, etc. The service provider maintains a supply 114 of replacement consumables 134.

In operation, the computer system 102 generates a document in an electronic form and transmits the document (in the form of a print job) to the printer 104. The printer 104 receives the job via the I/O port 130 and prints the document. Additionally, when the printer 104 is part of a multifunction device, the printer 104 may receive and print information from the communication link 120 or from a scanned image when operating as a copier. Additionally, the printer 104 may receive and print information from any of its media slots 140.

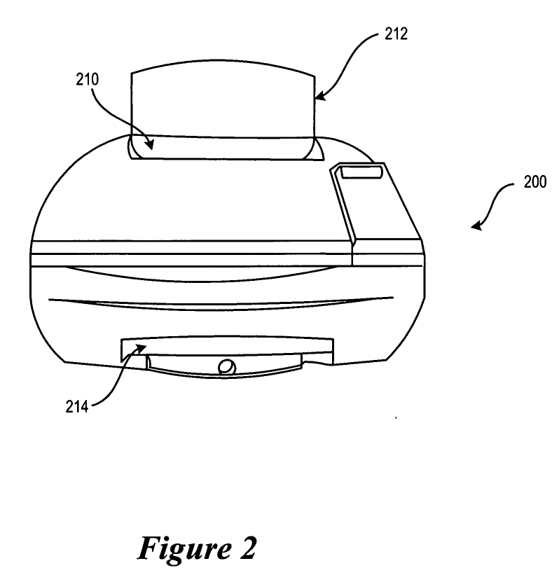

Referring to FIG. 2, a perspective view of an example top loading printer 200 is shown. Paper is fed to the top loading printer 200 a sheet feeder 210, which includes a paper support 212 for supporting and guiding the paper (or other material on which information is to be printed) into the printer 200. After printing, the paper exits via a recess 214 located close to the bottom of the printer 200.

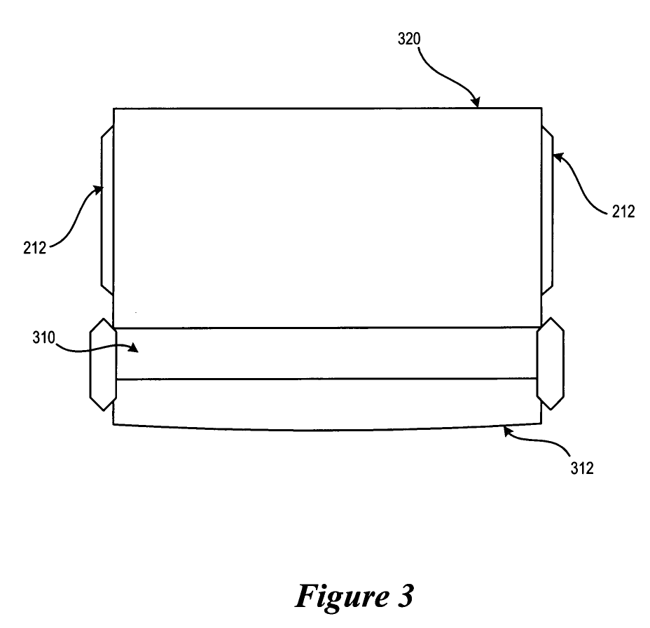

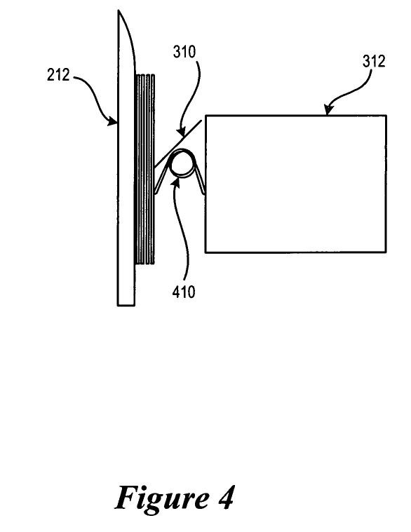

Referring to FIGS. 3 and 4, a top view and side view of a top loading printer 200 having a foreign object deflector 300 are shown. More specifically, the foreign object deflector 310 includes a foreign object deflector panel 310 and a spring 410. The foreign object deflector panel 310 is positioned between the top of the printer 312 and the paper 320 that is fed into the printer. The spring 410 is mechanically coupled between the panel 310 of the foreign object deflector and the top of the printer 312 to apply pressure on the paper when paper 320 is inserted into the sheet feeder 210. The panel 310 is angled downwardly from the direction in which paper is inserted into the sheet feeder 210 so that the panel automatically deflects when paper is inserted into the sheet feeder 210.

When the paper 320 is inserted into the sheet feeder 210 of the printer 320, the spring 410 of the foreign object deflector 310 is compressed so that the foreign object deflector 310 rests against the paper 320. The spring 410 is tensioned to provide a light tension against the paper 320. The light tension is enough so that the panel rests against the paper 320, while not impacting paper pick when paper is fed via the sheet feeder. In one embodiment, the spring is a butterfly type spring.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, it will be appreciated that other springs or spring type mechanisms can be used to apply the pressure to the panel to cause the panel to lightly rest against the paper.

Consequently, the invention is intended to be limited only by the spirit and scope of the appended claims, giving full cognizance to equivalents in all respects.

1. A printer comprising:
a printer housing, the printer housing including a top portion;
a sheet feeder positioned on the top portion of the printer housing, the sheet feeder including a foreign object deflector, the foreign object deflector including a foreign object deflector panel, the foreign object deflector panel being positioned between the printer housing and a paper path of the sheet feeder, the foreign object deflector being deflected when paper is inserted into the sheet feeder, the foreign object deflector being deflected by the paper.

2. The printer of claim 1 wherein:
the foreign object deflector includes a spring, the spring applying force to the foreign object deflector panel.

3. The printer of claim 2 wherein:
the spring includes a butterfly spring.

4. The printer of claim 2 wherein:
the spring applies enough force to cause the foreign object deflector panel to rest against paper inserted into the sheet feeder while not effecting paper pick of the sheet feeder.

5. (canceled)

6. An information handling system comprising:
a control system, the control system including a processor;
a printer housing, the printer housing including a top portion; and,
a sheet feeder positioned on the top portion of the printer housing, the sheet feeder including a foreign object deflector, the foreign object deflector including a foreign object deflector panel, the foreign object deflector panel being positioned between the printer housing and a paper path of the sheet feeder the foreign object deflector panel being deflected when paper is inserted into the sheet feeder, the foreign object deflector panel being deflected by the paper.

7. The information handling system of claim 6 wherein:
the foreign object deflector includes a spring, the spring applying force to the foreign object deflector panel.

8. The information handling system of claim 7 wherein:
the spring includes a butterfly spring.

9. The information handling system of claim 7 wherein:
the spring applies enough force to cause the foreign object deflector panel to rest against paper inserted into the sheet feeder while not effecting paper pick of the sheet feeder.

10. (canceled)

11. An apparatus for printing documents comprising:
a control system, the control system including a processor;
a housing, the housing including a top portion; and,
a sheet feeder positioned on the top portion of the housing, the sheet feeder including a foreign object deflector, the foreign object deflector including a foreign object deflector panel, the foreign object deflector panel being positioned between the housing and a path of the sheet feeder the foreign object deflector panel being deflected when paper is inserted into the sheet feeder, the foreign object deflector panel being deflected by the paper.

12. The apparatus of claim 11 wherein:
the foreign object deflector includes a spring, the spring applying force to the foreign object deflector panel.

13. The apparatus of claim 11 wherein:
the spring includes a butterfly spring.

14. The apparatus of claim 11 wherein:
the spring applies enough force to cause the foreign object deflector panel to rest against paper inserted into the sheet feeder while not effecting paper pick of the sheet feeder.

15. The apparatus of claim 11 wherein:
the foreign object deflector is deflected when paper is inserted into the sheet feeder.
